(19) United States
(12) Patent Application Publication
(10) Pub. No.: US 2015/0325109 A1
(43) Pub. Date: Nov. 12, 2015

(54) Quick Remote Control Method and Device

(71) Applicant: Looq System Inc., Santa Clara, CA (US)

(72) Inventor: Woody YU, Santa Clara, CA (US)

(73) Assignee: LOOQ SYSTEM INC., Santa Clara, CA (US)

(21) Appl. No.: 14/274,353

(22) Filed: May 9, 2014

(51) Int. Cl. G08C 17/02

(52) U.S. Cl. CPC G08C 17/02; G08C 2201/20; G08C 2201/92

(57) ABSTRACT

A quick remote control method comprises S1: receiving a key operation from a user, and determining whether the key operation is a continuous operation of a previous key operation. The method further comprises directly outputting a remote control signal of the key operation if the key operation is not the continuous operation of the previous key operation, or both outputting a remote control signal of the key operation and simultaneously recording a corresponding remote control code into the content of the continuous operation and proceeding to step S2 if the key operation is the continuous operation of the previous key operation. The method also comprises S2: determining whether the continuous operation is already completed, and returning to step S1 if the continuous operation has not yet been completed, or proceeding to step S3 if the continuous operation is already completed. The method further comprises S3: prompting the user to save the continuous operation and set a shortcut key for the continuous operation, setting the sequential set of the remote control codes of the respective key operations recorded in the content of the continuous operation as the remote control code of the shortcut key, and simultaneously inserting a given time interval between every two key operations. The method also comprises S4: when the user presses the shortcut key again, outputting the remote control code signals of the respective key operations in the sequential set in turn according to the time interval.

### FIELD

The present disclosure relates to the field of wireless communication technologies, and particularly to a quick remote control method and device.

### BACKGROUND

Remote control devices of conventional household appliances are accessory devices manufactured and sold with the corresponding household appliances. Generally, one function key on a remote control device corresponds to one remote control code. In use, a user presses keys on a remote control device as needed to select from a menu item by item in order to find a designated function. Although remote control devices significantly facilitate users' operations, it is no longer quick and convenient for users to control household appliances by using remote controllers to select from a menu item by item as smart household appliances develop and as household appliances provide more and more complicated functions.

Typically, using TV sets as an example, current smart TV sets may receive signals from many types of input sources for display. When a user switches between input sources, he needs to press keys and select for many times. For example, if the user wants to search, via the Internet, for relevant movie comments or publish his own feeling after he watches a movie from a DVD, he needs to select an input menu of the TV set, then switches the input source from the DVD device to a network mode, and then selects a network application to perform search or comment. Also, for example, when the user is currently watching a certain program or engaged in a certain task, and it occurs to him that his another favorite program is about to be broadcast but he does not clearly remember a specific broadcast time and channel number of the program, he has to switch the input over to TV and browse station by station frequently. If the program has not yet been broadcast, such procedure might need to be repeated for many times. In some cases, a plurality of devices are connected to the TV set. Upon ending the use, the user needs to use several remote controllers to turn off the TV set and the connecting devices one by one. Even if some remote controllers have powerful functions and can integrate remote control codes of many kinds of devices, the devices still need to be turned off by pressing power buttons of the respective devices one by one. As can be seen from the above, when combination input needs to be performed by using the current remote control manner, the user's operations are relatively complicated, time-consuming and strenuous; when malfunction occurs or an operation is cancelled due to operation delay, price for repeated operations is even larger.

### BRIEF SUMMARY

The technical problem to be solved by the present disclosure is how to improve quickness of a complicated remote control operation.

To solve the above problem, according to one aspect, the present disclosure provides a quick remote control method, comprising the following steps:

S1: receiving a key operation from a user, determining whether the key operation is a continuous operation of a previous key operation, and directly outputting a remote control signal of the key operation if the key operation is not the continuous operation of the previous key operation; both outputting a remote control signal of the key operation and simultaneously recording a corresponding remote control code into the content of the continuous operation and proceeding to step S2 if the key operation is the continuous operation of the previous key operation;

S2: determining whether the continuous operation is already completed, returning to step S1 if the continuous operation has not yet been completed; proceeding to step S3 if the continuous operation is already completed;

S3: prompting the user to save the continuous operation and set a shortcut key for the continuous operation, setting the sequential set of the remote control codes of the respective key operations recorded in the content of the continuous operation as the remote control code of the shortcut key, and simultaneously inserting a given time interval between every two key operations; and

S4: when the user presses the shortcut key again, outputting the remote control code signals of the respective key operations in the sequential set in turn according to the time interval.

Preferably, at step S1, whether the key operation is the continuous operation of a previous key operation is determined according to a time difference between and/or association of two operations.

Preferably, at step S2, whether the continuous operation is already completed is determined according to a function of the continuous operation and/or whether a next key operation is received in a certain time period.

Preferably, at step S3, the shortcut key is a self-defineable key or key combination.

Preferably, at step S4, the current shortcut key operation is interrupted immediately when the user operates a stop key.

According to another aspect, the present disclosure provides a quick remote control device, comprising:

an operation recording module configured to receive a key operation from a user, determine whether the key operation is a continuous operation of a previous key operation, and directly output a remote control signal of the key operation if the key operation is not the continuous operation of the previous key operation; both output a remote control signal of the key operation and simultaneously record a corresponding remote control code into the content of the continuous operation and initiate a completion determining module if the key operation is the continuous operation of the previous key operation;

a completion determining module configured to determine whether the continuous operation is already completed, re-initiate the operation recording module if the continuous operation has not yet been completed; initiate a setting module for processing if the continuous operation is already completed;

a setting module configured to prompt the user to save the continuous operation and set a shortcut key for the continuous operation, set the sequential set of the remote control codes of the respective key operations recorded in the content of the continuous operation as the remote control code of the shortcut key, and simultaneously insert a given time interval between every two key operations; and

a quick output module configured, when the user presses the shortcut key again, to output the remote control code signals of the respective key operations in the sequential set in turn according to the time interval.

Preferably, the device is applied to a dedicated remote controller having self-definable keys, or to a universal remote controller which may operate a plurality of apparatuses.

Preferably, the device further comprises a learning module configured for the user to learn remote control codes of different apparatuses.

Preferably, the device further comprises an interrupting module configured to interrupt the current shortcut key operation immediately when the user operates a stop key.

Preferably, the shortcut key is a key or a key combination.

### BRIEF DESCRIPTION OF DRAWINGS

FIG. 1 illustrates a flowchart of a quick remote control method according to one embodiment of the present disclosure.

FIG. 2 illustrates a block diagram of module structure of a quick remote control device according to one embodiment of the present disclosure.

### DETAILED DESCRIPTION OF PREFERRED EMBODIMENTS

Technical solutions in embodiments of the present disclosure are described clearly and completely with reference to figures in the embodiments of the present disclosure. Obviously, the depicted embodiments are preferred embodiments for implementing the present disclosure. The depictions aim to describe general principles of the present disclosure, not to limit the scope of the present disclosure. The scope of the present invention is defined by the appended claims. All other embodiments obtained by those having ordinary skill in the art based on embodiments of the present disclosure without making inventive contributions fall within the scope of the present disclosure.

One biggest drawback of a conventional remote controller is that one key has one single function; a combination of multiple functions requires a large amount of operations via continuous selections, which is time-consuming, strenuous and liable to errors; and a user's experience is undesirable. Embodiments of the present disclosure provide a quick remote control method, by which a self-definable combination of multiple key functions is recorded according to the user's operations so as to achieve one-key remote control of a complicated function, significantly simplifying complexity of the user's operations and improving the operation efficiency.

As compared with the prior art, the present disclosure provides quick remote control methods and devices, which simplify a complicated combination of remote control operations to operations of a few shortcut keys, do not require the user's excessive interference, substantially achieve automatic determination and setting of quick operations, greatly simplify the complexity of a combination operation, save the user's time, reduce an input error rate and improve operation efficiency.

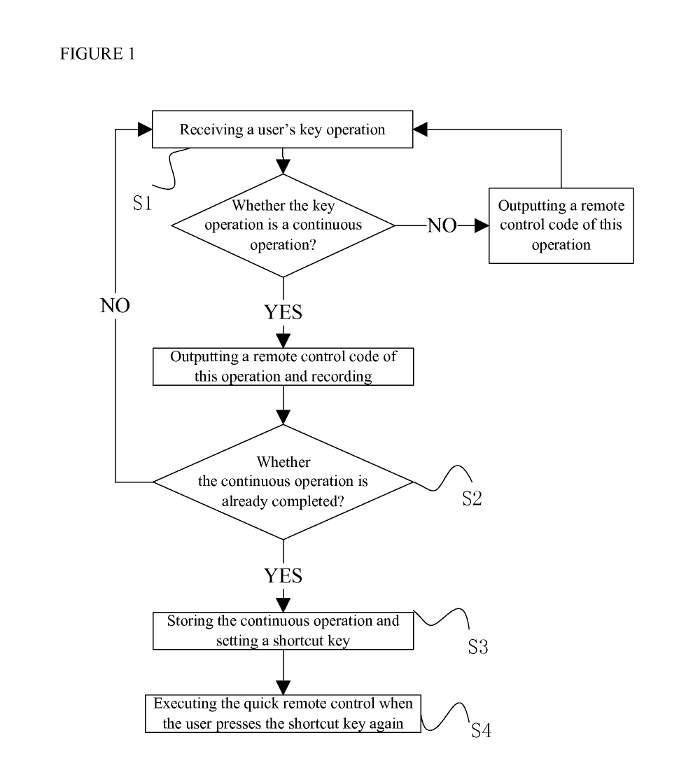

As shown in FIG. 1, the quick remote control method according to one embodiment of the present disclosure comprises the following steps:

S1: receiving a key operation from a user, determining whether the key operation is a continuous operation of a previous key operation, and directly outputting a remote control signal of the key operation if the key operation is not the continuous operation of the previous key operation; both outputting a remote control signal of the key operation and simultaneously recording a corresponding remote control code into the content of the continuous operation and proceeding to step S2 if the key operation is the continuous operation of the previous key operation;

S2: determining whether the continuous operation is already completed, returning to step S1 if the continuous operation has not yet been completed; proceeding to step S3 if the continuous operation is already completed;

S3: prompting the user to save the continuous operation and set a shortcut key for the continuous operation, setting the sequential set of the remote control codes of the respective key operations recorded in the content of the continuous operation as the remote control code of the shortcut key, and simultaneously inserting a given time interval between every two key operations;

S4: when the user presses the shortcut key again, outputting the remote control code signals of the respective key operations in the sequential set in turn according to the time interval.

In some preferred embodiments of the present disclosure, at step S1, whether the key operation is the continuous operation of a previous key operation is determined according to a time difference between and/or association of two operations. For instance, when the time difference of the two operations is obviously greater than an upper limit, the key operation is directly ascertained as an uncontinuous operation of the previous key operation; or when the time difference is less than a lower limit, the key operation is directly ascertained as the continuous operation of the previous key operation. For two operations with a time difference between the upper limit and the lower limit, whether the key operation is the continuous operation of a previous key operation is determined according to the association (e.g., continuous selection of stations upon browsing stations one by one can be regarded as a continuous operation). The upper limit and lower limit of the time difference may be default values or may be designated by the user according to the user's operation habits, e.g., a typical default value is one minute for the upper limit and five seconds for the lower limit. The present disclosure is not limited to these examples in this regard.

At step S2, whether the continuous operation is already completed is determined according to a function of the continuous operation and/or whether a next key operation is received in a certain time period. For example, the continuous operation is regarded as having already been completed if no other key operations are received within the upper limit (e.g., one minute) of the time difference of the continuous operation; or if the continuous operation is among some typical finishing acts (e.g., the user manually inputs a channel number and confirms the manual input); or even if an independent finishing key may be set to indicate the end of the continuous operation. The present disclosure is not limited to these examples in this regard.

At step S3, the shortcut key is a self-defineable key or key combination. Preferably, an undefined blank key is preferentially prompted to the user for use. According to a remote controller input manner, keys may be physical keys or virtual keys. The time interval may be a unified time interval or a time interval set according to types of key operations. For example, a unified time interval is three seconds; or a time interval of non-display type operations (e.g., selecting input source change) is set as a shorter time (e.g., less than one second) whereas the time interval of display type operations (e.g., browsing station by station) is set as a longer time (e.g., in a range between 5 seconds and 1 minute). The present disclosure is not limited to these examples in this regard. The time interval may be automatically set according to the operation type or self-defined by the user.

At step S4, a stop key may be set to immediately interrupt the current shortcut key operation when the user presses the stop key.

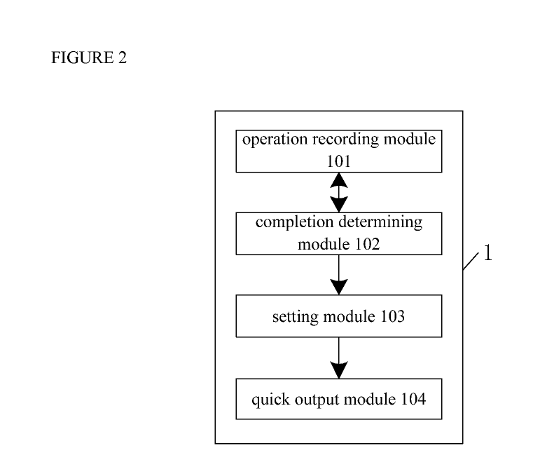

Those having ordinary skill in the art may appreciate that all or partial steps of the methods according to the above embodiments may be performed by a program to instruct relevant hardware to fulfill. The program may be stored in a computer-readable storage medium. When the program is executed, all steps of the methods in the above embodiments are performed. The storage medium may be a ROM/RAM, magnetic disk, optical disk, memory card or the like. Hence, referring to FIG. 2, corresponding to the above methods, the present disclosure meanwhile discloses a quick remote control device, comprising:

an operation recording module 101 configured to receive a key operation from a user, determine whether the key operation is a continuous operation of a previous key operation, and directly output a remote control signal of the key operation if the key operation is not the continuous operation of the previous key operation; both output a remote control signal of the key operation and simultaneously record a corresponding remote control code into the content of the continuous operation and initiate a completion determining module 102 if the key operation is the continuous operation of the previous key operation;

a completion determining module 102 configured to determine whether the continuous operation is already completed, re-initiate the operation recording module 101 if the continuous operation has not yet been completed; initiate a setting module 103 for processing if the continuous operation is already completed;

a setting module 103 configured to prompt the user to save the continuous operation and set a shortcut key for the continuous operation, set the sequential set of the remote control codes of the respective key operations recorded in the content of the continuous operation as the remote control code of the shortcut key, and simultaneously insert a given time interval between every two key operations; and

a quick output module 104 configured, when the user presses the shortcut key again, to output the remote control code signals of the respective key operations in the sequential set in turn according to the time interval.

The above embodiment may be applied to a dedicated remote controller having self-definable keys, but it is preferably applied to a universal remote controller which may operate various types of apparatuses, to achieve a richer combination remote control function. A typical universal remote control device, e.g., a mobile terminal (including but not limited to a mobile phone, a flat panel computer, and the like), stores remote control codes of various types of apparatuses, and may control a plurality of apparatus in a graphic user interface and also support more complicated and a larger number of shortcut key definitions. Certainly, no matter whether it is a dedicated remote controller or a universal remote control device, if it has a remote control code learning function, obviously combination remote control of multiple apparatuses may be achieved by learning remote control codes of different apparatuses.

Technical solutions of the present disclosure provides quick remote control methods and devices, which may simplify a complicated combination of remote control operations to operations of a few shortcut keys, do not require the user's excessive interference, substantially achieve automatic determination and setting of quick operations, greatly simplify the complexity of a combination operation, save the user's time, reduce an input error rate and improve operation efficiency.

The above description illustrates and depicts several preferred embodiments. As stated above, it should be appreciated that the present disclosure is not limited to the forms revealed in the text, and should not be considered as excluding other embodiments. The present disclosure may be used for various other combinations, modifications and environments, and can be modified through the above teaching or technologies or knowledge in the relevant fields within the scope of inventive contribution of the present disclosure. Any modifications and variations made by those skilled in the art all should be regarded as falling within the scope defined by the appended claims of the present disclosure so long as they do not depart from the spirit and scope of the present disclosure.

1. A quick remote control method, comprising:
S1: receiving a key operation from a user, determining whether the key operation is a continuous operation of a previous key operation, and directly outputting a remote control signal of the key operation if the key operation is not the continuous operation of the previous key operation; both outputting a remote control signal of the key operation and simultaneously recording a corresponding remote control code into the content of the continuous operation and proceeding to step S2 if the key operation is the continuous operation of the previous key operation;
S2: determining whether the continuous operation is already completed, returning to step S1 if the continuous operation has not yet been completed; proceeding to step S3 if the continuous operation is already completed;
S3: prompting the user to save the continuous operation and set a shortcut key for the continuous operation, setting the sequential set of the remote control codes of the respective key operations recorded in the content of the continuous operation as the remote control code of the shortcut key, and simultaneously inserting a given time interval between every two key operations; and
S4: when the user presses the shortcut key again, outputting the remote control code signals of the respective key operations in the sequential set in turn according to the time interval.

2. The method according to claim 1, wherein, at step S1, whether the key operation is the continuous operation of a previous key operation is determined according to a time difference between the two operations.

3. The method according to claim 1, wherein, at step S1, whether the key operation is the continuous operation of a previous key operation is determined according to association of the two operations.

4. The method according to claim 1, wherein, at step S2, whether the continuous operation is already completed is determined according to a function of the continuous operation.

5. The method according to claim 1, wherein, at step S2, whether the continuous operation is already completed is determined according to whether a next key operation is received within a certain time period.

6. The method according to claim 1, wherein, at step S3, the shortcut key is a self-defineable key or key combination.

7. The method according to claim 1, wherein, at step S4, the current shortcut key operation is interrupted immediately when the user operates a stop key.

8. A quick remote control device, comprising:
an operation recording module configured to receive a key operation from a user, determine whether the key operation is a continuous operation of a previous key operation, and directly output a remote control signal of the key operation if the key operation is not the continuous operation of the previous key operation; both output a remote control signal of the key operation and simultaneously record a corresponding remote control code into the content of the continuous operation and initiate a completion determining module if the key operation is the continuous operation of the previous key operation;
a completion determining module configured to determine whether the continuous operation is already completed, re-initiate the operation recording module if the continuous operation has not yet been completed; initiate a setting module for processing if the continuous operation is already completed;
a setting module configured to prompt the user to save the continuous operation and set a shortcut key for the continuous operation, set the sequential set of the remote control codes of the respective key operations recorded in the content of the continuous operation as the remote control code of the shortcut key, and simultaneously insert a given time interval between every two key operations; and
a quick output module configured, when the user presses the shortcut key again, to output the remote control code signals of the respective key operations in the sequential set in turn according to the time interval.

9. The device according to claim 8, wherein the device is applied to a dedicated remote controller having self-definable keys.

10. The device according to claim 8, wherein the device is applied to a universal remote controller which operates many a plurality of apparatuses.

11. The device according to claim 8, wherein the device further comprises:
a learning module configured for the user to learn remote control codes of different apparatuses.

12. The device according to claim 8, wherein the device further comprises:
an interrupting module configured to interrupt the current shortcut key operation immediately when the user operates a stop key.

13. The device according to claim 8, wherein the shortcut key is a key.

14. The device according to claim 8, wherein the shortcut key is a key combination.
